(19) United States
(12) Patent Application Publication
(10) Pub. No.: US 2017/0110027 A1
(43) Pub. Date: Apr. 20, 2017

(54) DENTAL ASSISTANT TRAINING AND CUSTOMIZATION SYSTEM

(71) Applicant: Tasha Knight, Decatur, GA (US)

(72) Inventor: Tasha Knight, Decatur, GA (US)

(21) Appl. No.: 14/883,403

(22) Filed: Oct. 14, 2015

(51) Int. Cl. G09B 19/00; G09B 5/02

(52) U.S. Cl. CPC G09B 19/0084; G09B 5/02

(57) ABSTRACT

Implementations of a dental assistant training and customization system are provided. In some implementations, to create a custom training system, the dental assistant training and customization system is configured to allow a dental office to upload an image of a tray layout of dental instruments and materials for at least a first dental service based on the tray layout at the dental office. The dental office can input the names of the dental instruments and material illustrated in the image. The dental office can also input the names of one or more pieces of equipment used for the first dental service at the dental office. The dental office can also upload a video illustrating the first dental service. The dental office can also input one or more dental procedure codes associated with the first dental service. In some implementations, the images, videos, and information inputted by the dental office may then be used to train dental assistants on the instruments, dental materials, dental procedure codes, dental equipment, and other information for dental services for a particular dental office.

### TECHNICAL FIELD

This disclosure relates to implementations of a dental assistant training and customization system.

### BACKGROUND

There is a high turnover rate of dental assistants. Furthermore, new dental assistants are not properly trained to work in dental offices. Still further, each dental office operates differently. Thus, even experienced dental assistants are not trained to work in a new dental office. Each time a dental office hires a new dental assistant, time must be expended to train the new dental assistant. There does not exist a relatively easy method to create an automated training system for dental assistants that is customized for a specific dental office.

### BRIEF DESCRIPTION OF THE DRAWINGS

FIGS. 1A and 1B illustrate elements of an example system to create an automated training system for dental assistants that is customized for a specific dental office in accordance with the present disclosure.

FIG. 2A-2F illustrates example screen shots of an example training and customization system in accordance with the present disclosure.

FIG. 3 illustrates an example environment for a dental assistant training and customization system in accordance with the present disclosure.

FIG. 4 illustrates another example environment for a dental assistant training and customization system in accordance with the present disclosure.

FIG. 5 illustrates an example computer system in accordance with the present disclosure.

### DETAILED DESCRIPTION

Implementations of a dental assistant training and customization system (DATCS) are provided. In some implementations, to create a custom training system, the DATCS is configured to allow a dental office to upload an image of a tray layout of dental instruments and materials for at least a first dental service based on the tray layout at the dental office. The dental office can input the names of the dental instruments and material illustrated in the image. The dental office can also input the names of one or more pieces of equipment used for the first dental service at the dental office. The dental office can also upload a video illustrating the first dental service. The dental office can also input one or more dental procedure codes associated with the first dental service. In some implementations, the images, videos, and information inputted by the dental office may then be used to train dental assistants on the instruments, dental materials, dental procedure codes, dental equipment, and other information for dental services for a particular dental office

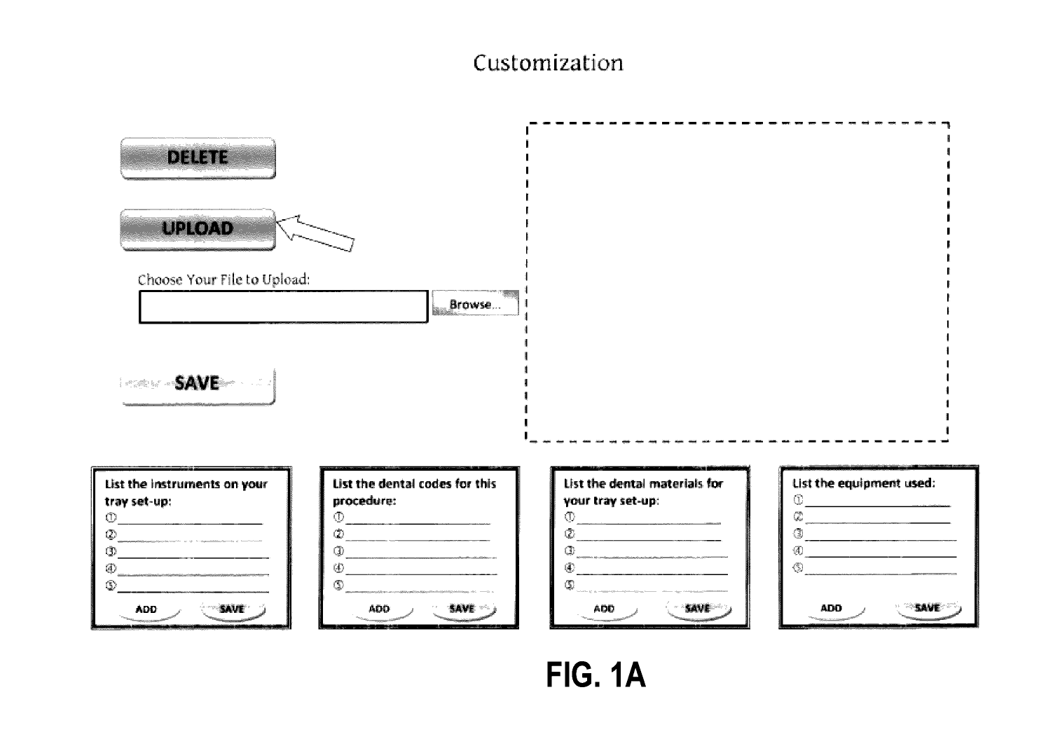

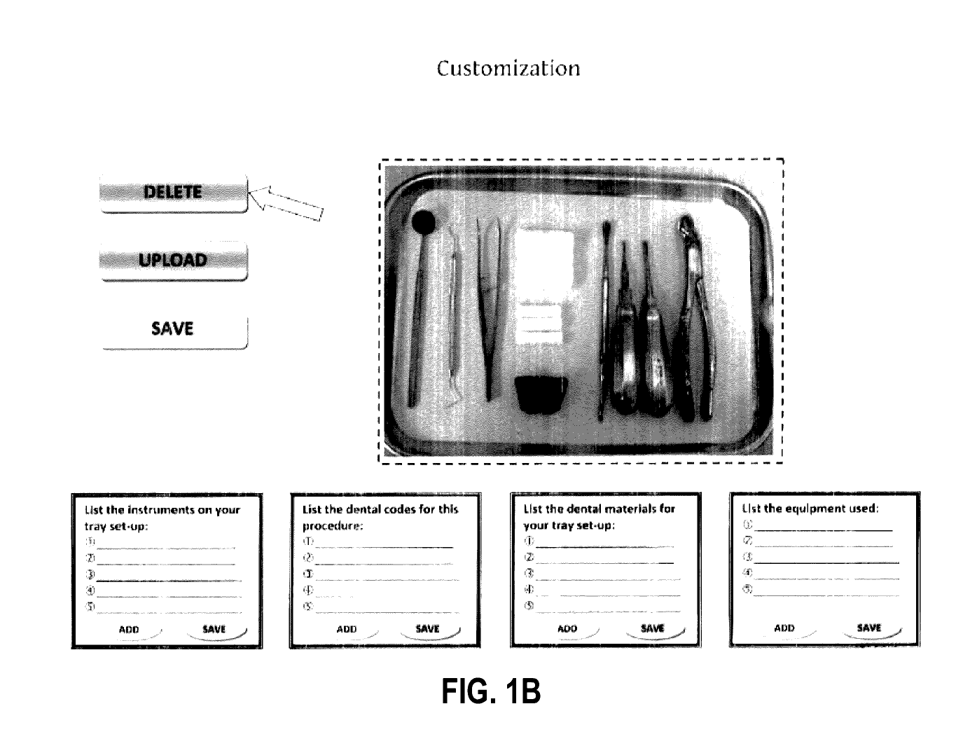

FIGS. 1A and 1B illustrate an example DATCS to create an automated training system for dental assistants that is customized for a specific dental office in accordance with the present disclosure.

As shown in FIG. 1A, to create a custom training system, the DATCS may be configured to permit the user to upload a custom image of a tray layout of the dental instruments and materials for a particular dental service. For example, in some implementations, the dental service may be x-rays, whitening, impression, child prophy, dentures, adult prophy, partials, filling, crown, laser, diagnostic, implants, extraction, bridge, SRP (periodontal), sealants, lumineers/veneers, shade selection, or any other dental service. In some implementations, the custom image may be an image of a tray layout used for a particular dental office where a trainee is or will be working. In some implementations, the DATCS may be configured to permit the user to upload a non-custom image of a tray layout of the dental instruments and materials for a particular dental service.

In some implementations, the DATCS may be configured to permit an user to upload a custom video illustrating a particular dental service. In some implementations, the custom video may be a video illustrating a particular dental service performed at a particular dental office where a trainee is or will be working. In some implementations, the DATCS may be configured to permit the user to upload a non-custom video illustrating a particular dental service.

As shown in FIGS. 1A and 1B, in some implementations, the DATCS may be configured to permit the user to input the instruments illustrated on the image of the tray layout and/or used for a particular service.

As shown in FIGS. 1A and 1B, in some implementations, the DATCS may be configured to permit the user to input dental procedure codes for a particular service. In some implementations, a dental procedure code may be a code used for reporting a dental service(s) to a third party payer. In some implementations, the DATCS may be configured to permit the user to input additional dental procedure codes for additional dental services associated with a particular service selected.

As shown in FIGS. 1A and 1B, in some implementations, the DATCS may be configured to permit the user to input the dental materials for a particular service.

As shown in FIGS. 1A and 1B, in some implementations, the DATCS may be configured to permit the user to input the equipment used for a particular service.

In some implementations, the DATCS may be configured to permit the user to input any other information for a particular service or dental office. For example, in some implementations, the DATCS may be configured to permit the user to input custom notes (e.g., “patients 15 and under are covered”) relevant to coverage by a particular insurance company regarding a particular dental service (e.g., “sealants”). In some implementations, the DATCS may be configured to allow a user to select an insurance company from a list or to enter the name of an insurance company. After selecting or entering the name of an insurance company, the DATCS may be configured to permit the user to input notes relevant to the insurance company (e.g., information regarding coverage or any other information) for a particular service.

In some implementations, the DATCS may be configured to permit the user to input custom description of services for dental services used at a particular dental office.

In some implementations, the DATCS may be configured to permit the user to upload a consent form.

In some implementations, the DATCS may be configured to permit the user to upload before and after images and/or videos related to a dental service. For example, the DATCS may be configured to permit the user to upload one or more images and/or videos of the object of a dental service (e.g., a person's mouth or teeth or a portion thereof) before the dental service and one or more images and/or videos of the object of the dental service after the dental service.

In some implementations, the images, videos, and information inputted by the user may then be used to train dental assistants on the instruments, dental materials, dental procedure codes, dental equipment, and other information for dental services for a particular dental office (e.g., the dental office where the dental assistants is or will be working).

In some implementations, the DATCS may be used to train persons associated with dental supply vendors.

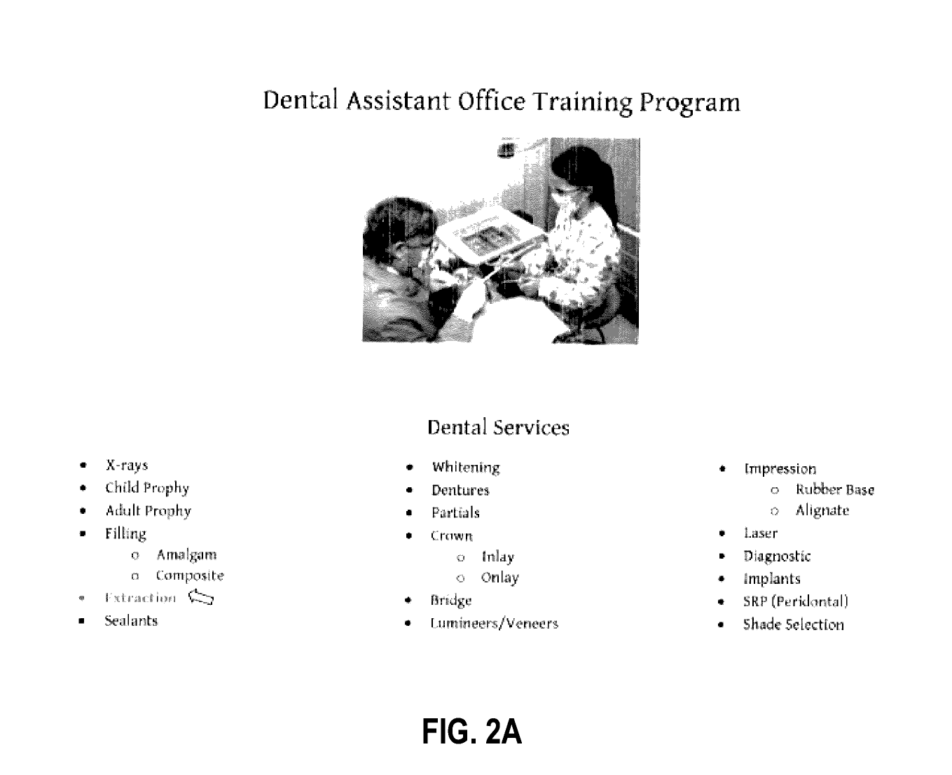

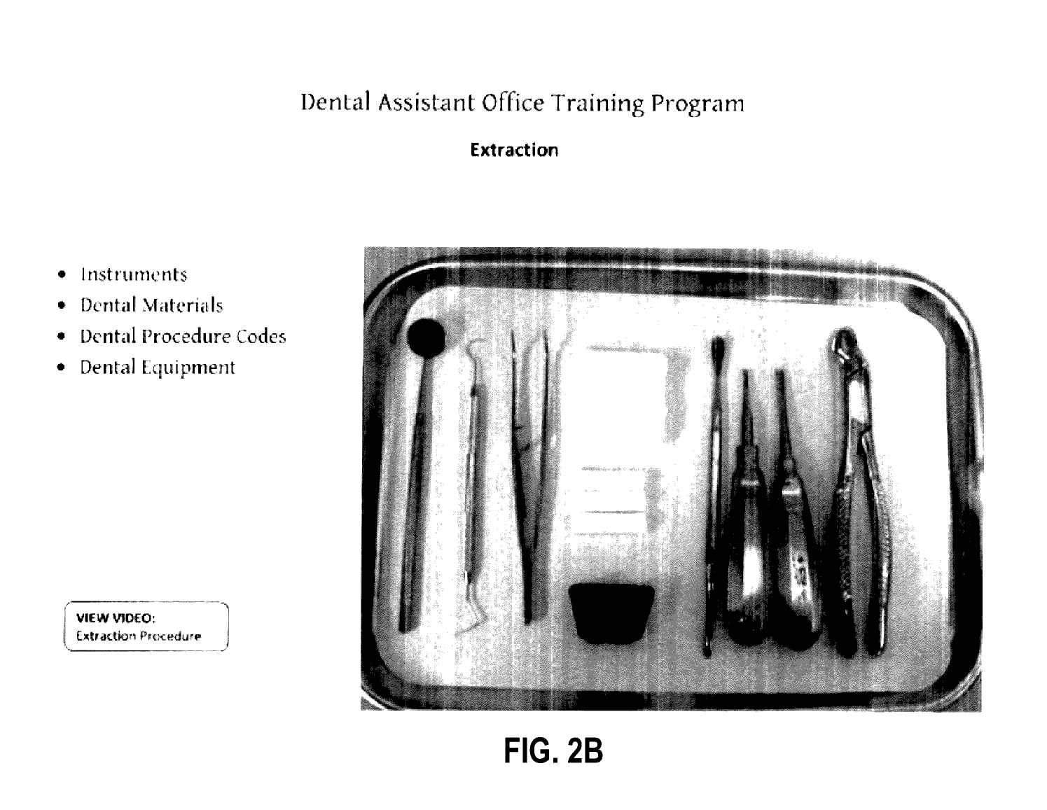

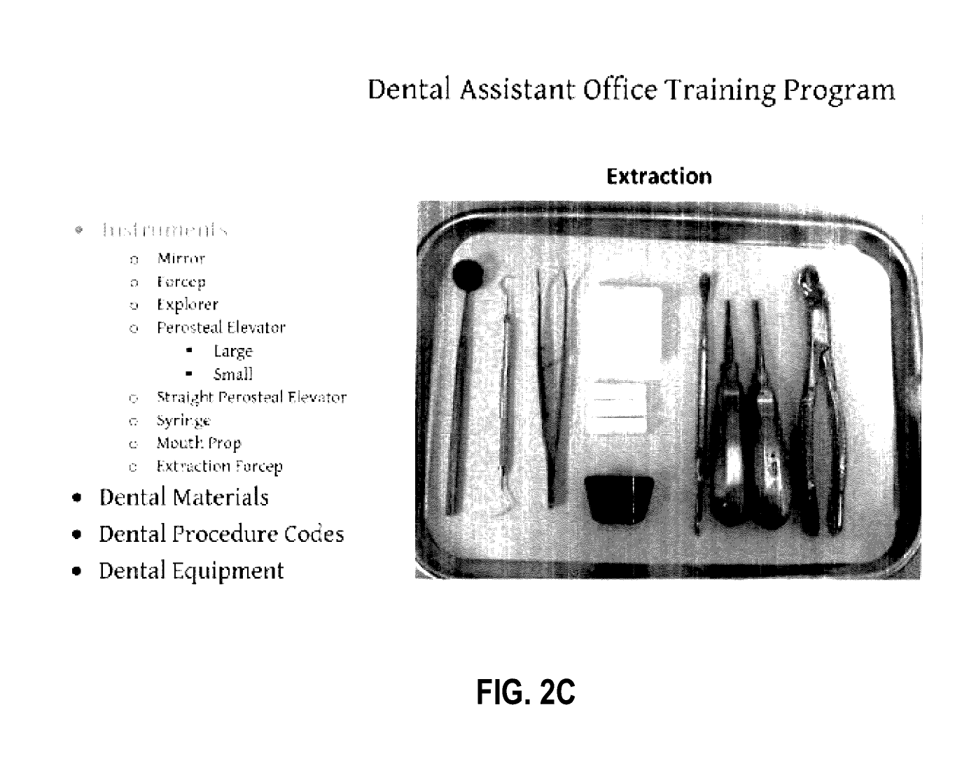

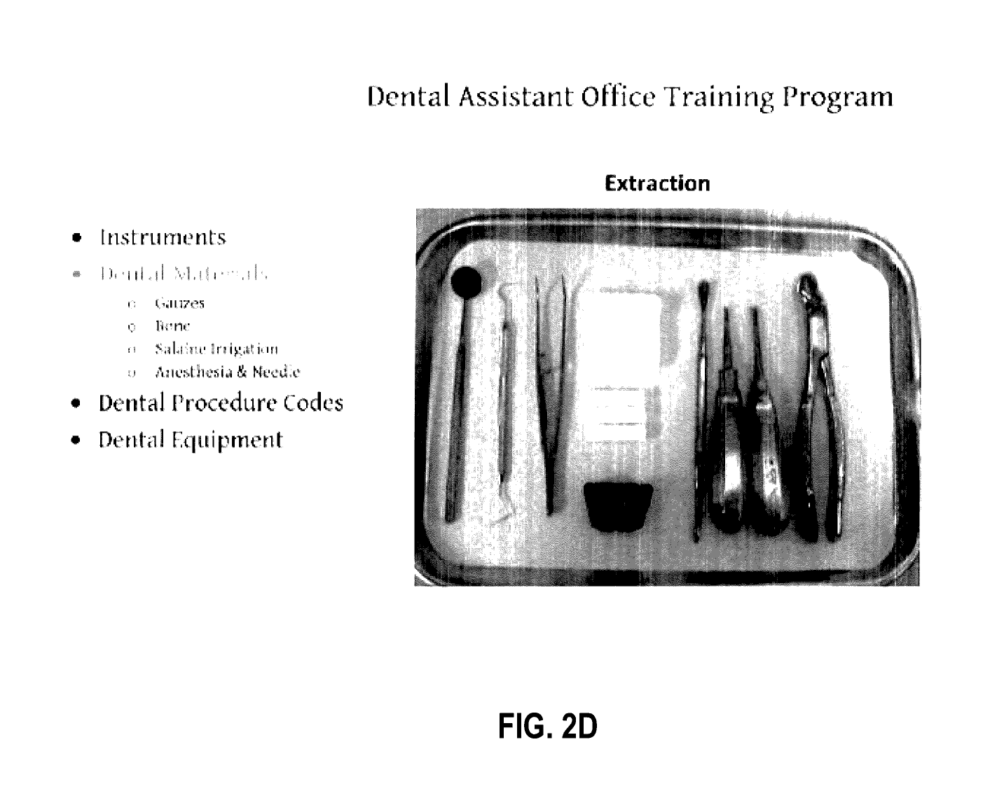

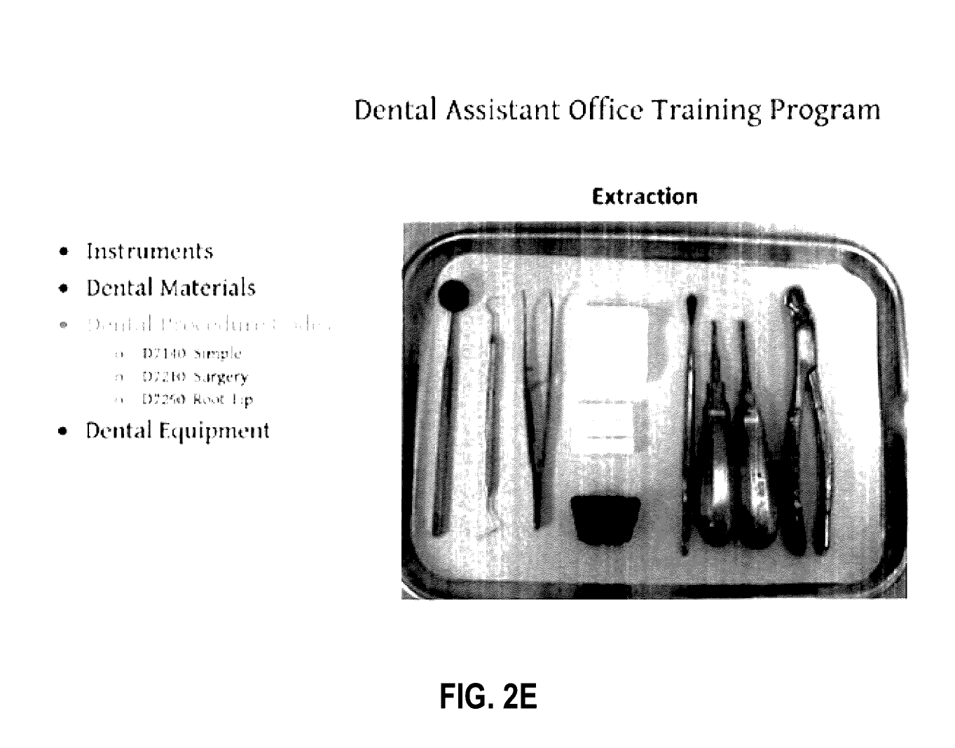

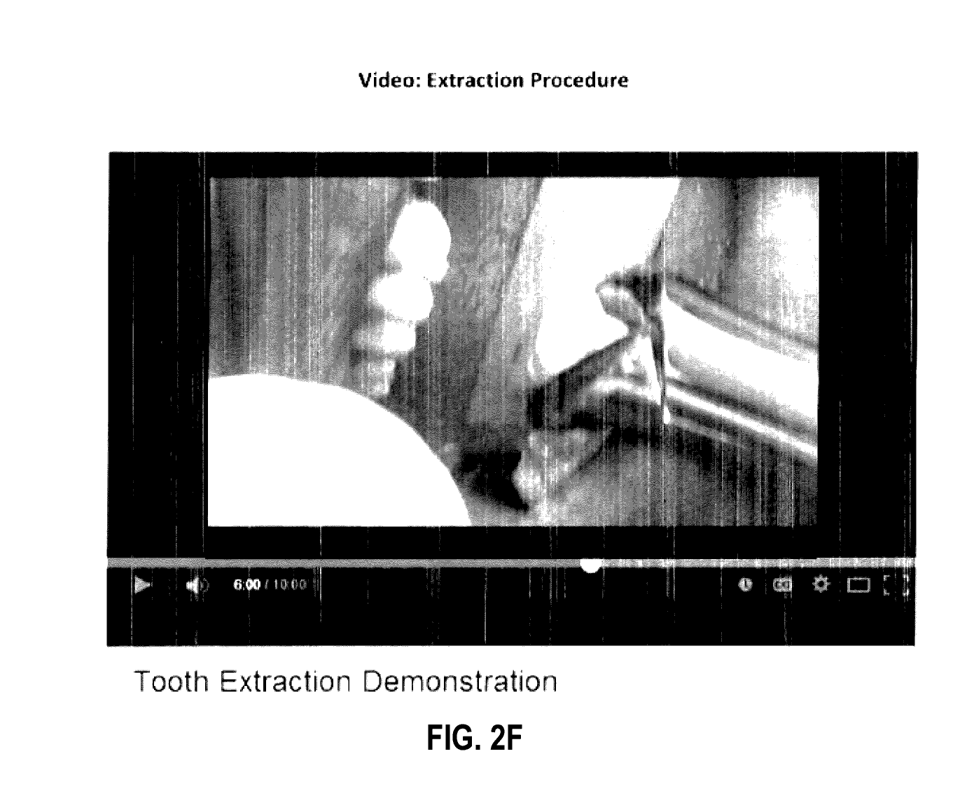

FIGS. 2A-2F illustrate example screen shots of a DATCS to train dental assistants in accordance with the present disclosure.

As shown in FIG. 2A, the DATCS may be configured to display a list of dental services for the dental assistant to select. For example, as shown in FIG. 2A, the dental assistant may choose “Extraction”.

As shown in FIG. 2B, upon selection of a dental service, the DATCS may be configured to display a tray layout and categories relevant to the dental service selected. For example, as shown in FIG. 2B, the dental assistant may select to learn about the instruments, materials, codes, or equipment used for the selected dental service. For example, as shown in FIG. 2C, for the selected “Extraction” dental service, if the dental assistant chooses to learn about instruments used for an extraction, the DATCS may display a list of instruments used for an extraction. In some implementations, the instruments listed may be the instruments inputted for the particular service during the customization stage. In some implementations, the DATCS may also display a tray layout. In some implementations, the tray layout displayed may be the image uploaded for the particular service during the customization stage.

As another example, as shown in FIG. 2D, for the selected “Extraction” dental service, if the dental assistance chooses to learn about materials used for an extraction, the DATCS may display a list of materials used for an extraction. In some implementations, the materials listed may be the materials inputted for the particular service during the customization stage. In some implementations, the DATCS may also display a tray layout. In some implementations, the tray layout displayed may be the image uploaded for the particular service during the customization stage.

As another example, as shown in FIG. 2E, for the selected “Extraction” dental service, if the dental assistance chooses to learn about dental procedure codes used for an extraction, the DATCS may display a list of dental procedure codes used for an extraction. In some implementations, the codes listed may be the codes inputted for the particular service during the customization stage. In some implementations, the DATCS may also display a tray layout. In some implementations, the tray layout displayed may be the image uploaded for the particular service during the customization stage.

In some implementations, other categories may be selected with corresponding display screens displaying the relevant information, images, and/or videos. In some implementations, the relevant information, images, and/or videos may include information, images, and/or videos inputted during the customization stage.

In some implementations, the DATCS may provide the option to watch a procedure for the dental service. For example, FIG. 2F illustrates a screenshot of an example video demonstration of a tooth extraction.

In some implementations, certain proportions of the DATCS may be restricted to certain users. In some implementations, certain proportions of the DATCS may be restricted to certain users based on job duties. For example, a screen associated with dental procedure codes may be accessed by assistants that work in the front office and assistants working outside the front office may be denied access to the screen.

The above training and customization system can be used for other medical areas (e.g., dermatology or any other medical area). For example, the above training and customization system can be used to create an automated training system for medical office assistants that is customized for a specific medical office.

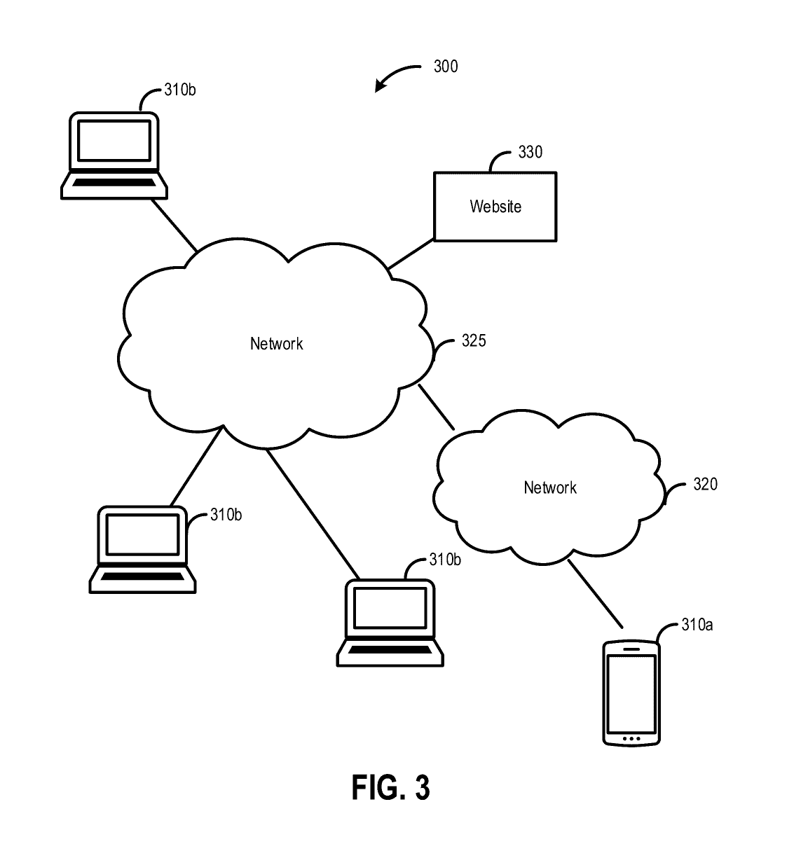

FIG. 3 illustrates an example environment 300 for a dental assistant training and customization system (DATCS) according to the present disclosure.

As shown in FIG. 3, in some implementations, the environment 300 can include client devices 310a and 310b (collectively client device 310), a wireless cellular network 320, a network 325, and a website 330.

In some implementations, the website 330 may be communicatively connected with a DATCS server. In some implementations, the DATCS server is configured to provide customization and training as discussed above.

In some implementations, the website 330 may be hosted on a DATCS server. Client devices 310a and 310b are depicted as a mobile phone 310a and desktop computer 310b, respectively, but client devices 310 may comprise any type of computing device, such as a desktop computer system, a laptop, a smartphone, a mobile telephone, a tablet-style computer, or any other computing handheld electronic device.

In some implementations, the client device 310a can connect to the network 325 through a wireless cellular network 320, such as GPRS-based and CDMA-based wireless networks, as well as 802.16 WiMax and long-range wireless data networks.

Client devices 310a and 310b can interact with the website 330 via an application, such as a web browser or a native application, residing on the client devices 310a and 310b to access the DATCS server. The client devices may be used to upload images, videos, and information or for training as discussed above.

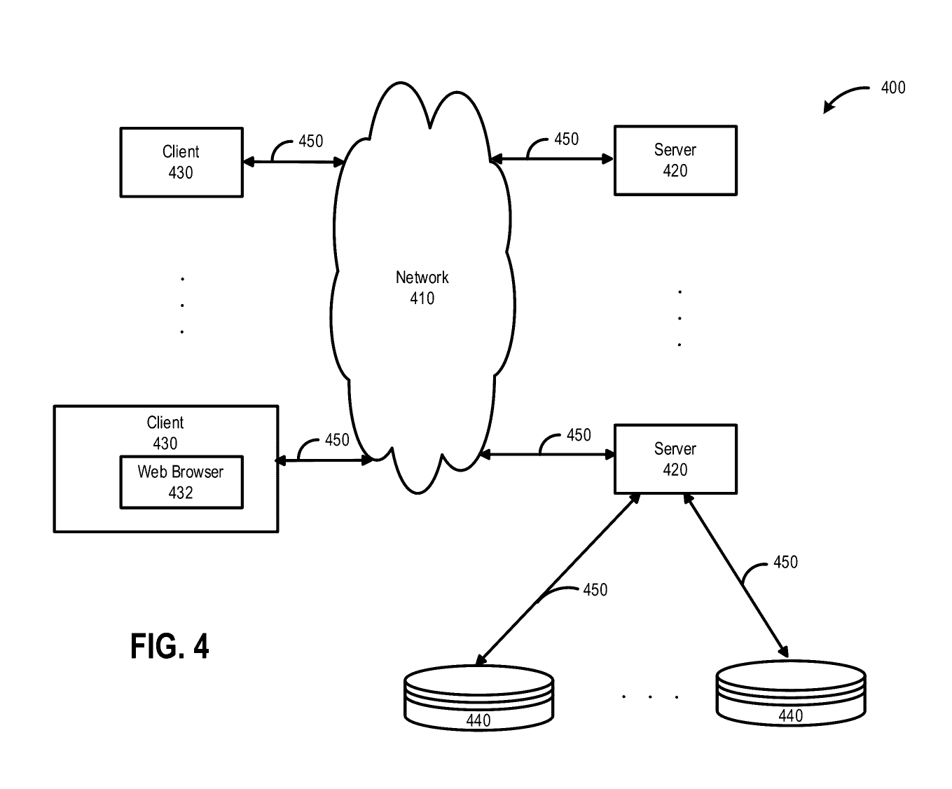

FIG. 4 illustrates another example environment 400 for a DATCS according to the present disclosure.

The example environment 400 can include a network 410, one or more servers 420, and one or more clients 430. The example environment 400 also can include one or more data storage 440 linked to one or more servers 420. Particular embodiments may be implemented in network environment 400. For example, applications used to render the user interfaces to perform the functions described above may be written in software programs hosted by one or more servers 420.

In some implementations, network 410 may be an intranet, an extranet, a virtual private network (VPN), a local area network (LAN), a wireless LAN (WLAN), a wide area network (WAN), a metropolitan area network (MAN), a portion of the Internet, or another network 410 or a combination of two or more such networks 410. The present disclosure contemplates any suitable network 410.

One or more links 450 couple a server 420 or a client 430 to network 410. In some implementations, one or more links 450 each can include one or more wired, wireless, or optical links 450. In some implementations, one or more links 450 each can include an intranet, an extranet, a VPN, a LAN, a WLAN, a WAN, a MAN, a portion of the Internet, or another link 450 or a combination of two or more such links 450. The present disclosure contemplates any suitable links 450 coupling servers 420 and clients 430 to network 410.

In some implementations, each server 420 may be a unitary server or may be a distributed server spanning multiple computers or multiple datacenters. Servers 420 may be of various types, such as, for example and without limitation, web server, file server, application server, exchange server, database server, or proxy server. In some implementations, each server 420 may include hardware, software, or embedded logic components or a combination of two or more such components for carrying out the appropriate functionalities implemented or supported by server 420. For example, a web server is generally capable of hosting websites containing web pages or particular elements of web pages. More specifically, a web server may host HTML files or other file types, or may dynamically create or constitute files upon a request, and communicate them to clients 430 in response to HTTP or other requests from clients 430. A database server is generally capable of providing an interface for managing data stored in one or more data stores.

In some implementations, one or more data storages 440 may be communicatively linked to one or more servers 420 via one or more links 450. In some implementations, data storages 440 may be used to store various types of information. In some implementations, the information stored in data storages 440 may be organized according to specific data structures. In particular embodiment, each data storage 440 may be a relational database. Particular embodiments may provide interfaces that enable servers 420 or clients 430 to manage, e.g., retrieve, modify, add, or delete, the information stored in data storage 440. In some implementations, one or more data storages 440 may store information, images, and videos uploaded and used in the DATCS.

In some implementations, each client 430 may be an electronic device including hardware, software, or embedded logic components or a combination of two or more such components and capable of carrying out the appropriate functions implemented or supported by client 430. For example and without limitation, a client 430 may be any type of computing device such as a desktop computer system, a laptop, a smartphone, a mobile telephone, a tablet-style computer, or any other handheld electronic device. The present disclosure contemplates any suitable clients 430. A client 430 may enable a network user at client 430 to access network 430. A client 430 may enable its user to communicate with other users at other clients 430.

A client 430 may have a web browser 432, such as MICROSOFT INTERNET EXPLORER, GOOGLE CHROME, MOZILLA FIREFOX, or any other future developed web browser and may have one or more add-ons, plug-ins, or other extensions. A user at client 430 may enter a Uniform Resource Locator (URL) or other address directing the web browser 432 to a server 420, and the web browser 432 may generate a Hyper Text Transfer Protocol (HTTP) request and communicate the HTTP request to server 420. Server 420 may accept the HTTP request and communicate to client 430 one or more Hyper Text Markup Language (HTML) files responsive to the HTTP request. Client 430 may render a web page based on the HTML files from server 420 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

In some implementations, a client 430 having a web browser 432 can connect to a server 420 to use implementations of the DATCS. In some implementations, input received from a user may be stored in a data storage 340 communicatively linked to the servers 420. In some implementations, the data storage 440 may be a database.

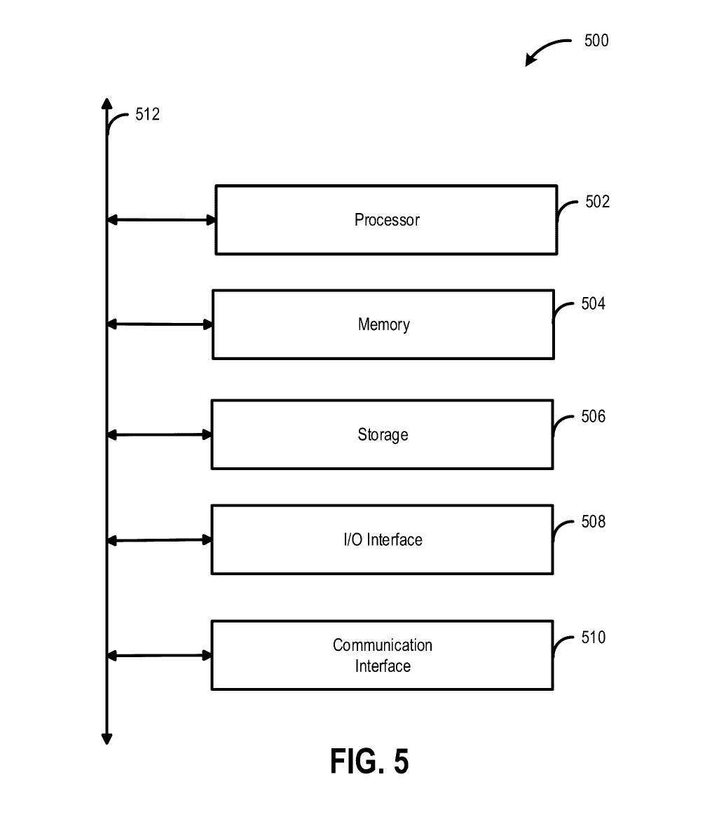

FIG. 5 illustrates an example computer system 500, which may be used with some embodiments of the present invention. This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these. Where appropriate, computer system 500 may include one or more computer systems 500; be unitary or distributed; span multiple locations; span multiple machines; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

For example, in some implementations, the computer system 500 may receive information input by a user and process such information as described above. In some implementations, for example, the computer system 500 may prompt the user for inputs, store the inputs, and display the screen shots as discussed above.

In some implementations, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In some implementations, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In some implementations, processor 502 may include one or more internal caches for data, instructions, or addresses. The present disclosure contemplates processor 502 including any suitable number of any suitable internal caches, where appropriate. As an example and not by way of limitation, processor 502 may include one or more instruction caches, one or more data caches, and one or more translation look-aside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In some implementations, processor 502 may include one or more internal registers for data, instructions, or addresses. The present disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In some implementations, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In some implementations, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In some implementations, one or more memory management units (MMUs) reside between processor 502 and memory 504 and facilitate accesses to memory 504 requested by processor 502. In some implementations, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 504 may include one or more memories 502, where appropriate. Although this disclosure describes and illustrates particular memory, this disclosure contemplates any suitable memory.

In some implementations, storage 506 includes mass storage for data or instructions. As an example and not by way of limitation, storage 506 may include an HDD, a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In some implementations, storage 506 is non-volatile, solid-state memory. In some implementations, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In some implementations, I/O interface 508 includes hardware, software, or both providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In some implementations, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In some implementations, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

This disclosure contemplates one or more computer-readable storage media implementing any suitable storage. In some implementations, a computer-readable storage medium implements one or more portions of processor 602 (such as, for example, one or more internal registers or caches), one or more portions of memory 604, one or more portions of storage 606, or a combination of these, where appropriate. In some implementations, a computer-readable storage medium implements RAM or ROM. In some implementations, a computer-readable storage medium implements volatile or persistent memory. In some implementations, one or more computer-readable storage media embody software.

Herein, reference to software may encompass one or more applications, bytecode, one or more computer programs, one or more executables, one or more instructions, logic, machine code, one or more scripts, or source code, and vice versa, where appropriate. In some implementations, software includes one or more application programming interfaces (APIs). This disclosure contemplates any suitable software written or otherwise expressed in any suitable programming language or combination of programming languages. In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code). In some implementations, software is expressed in JAVA. In some implementations, software is expressed in Hyper Text Markup Language (HTML), Extensible Markup Language (XML), or other suitable markup language.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website. Any computer-based system that provides networking functionality can be used in accordance with the present invention even if it relies, for example, on e-mail, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

1. A computer-implemented method for training dental assistants, the method comprising:
uploading by a dental office an image of a tray layout of dental instruments and materials for at least a first dental service based on the tray layout at the dental office and inputting the names of the dental instruments and material illustrated in the image;
inputting by the dental office the names of one or more pieces of equipment used for the first dental service at the dental office;
uploading by the dental office a video illustrating the first dental service; and
inputting by the dental office one or more dental procedure codes associated with the first dental service.

2. The computer-implemented method of claim 1, the method further comprising:
displaying to a dental assistant a list of dental services to be selected wherein the list includes the first dental service;
selecting by the dental assistant the first dental service;
displaying the uploaded image of the tray layout of dental instruments and materials for the first dental service; and
displaying a list of categories to be selected by the dental assistant for the selected dental service including instruments, materials, dental codes, and equipment used for the selected dental service and displaying the inputted instruments, materials, dental codes, and equipment used for the selected dental service based on the category selected.

3. The computer-implemented method of claim 2, the method further comprising:
selecting by the dental assistant to watch a video illustrating the first dental service and displaying the uploaded video.

4. The computer-implemented method of claim 1, the method further comprising:
inputting by the dental office one or more dental procedure codes for dental services associated with the first dental service.

5. The computer-implemented method of claim 1, the method further comprising:
inputting by the dental office information relevant to insurance coverage for a dental service by a particular insurance company.

6. The computer-implemented method of claim 1, the method further comprising:
inputting by the dental office a description of service for the first dental service.

7. The computer-implemented method of claim 1, the method further comprising:
uploading by the dental office a consent form.

8. The computer-implemented method of claim 1, the method further comprising:
uploading by the dental office an image of an object of a dental service before the dental service and an image of the object of the dental service after the dental service.

9. A non-transitory computer readable medium containing instructions that, when executed by a processor on a computing device, cause the computing device to:
store an uploaded image of a tray layout of dental instruments and materials for at least a first dental service by a dental office based on the tray layout at the dental office;
store inputted names of the dental instruments and material illustrated in the image;
store inputted names by the dental office of one or more pieces of equipment used for the first dental service at the dental office;
store an uploaded video by the dental office illustrating the first dental service; and
store one or more inputted dental procedure codes by the dental office associated with the first dental service.

10. The non-transitory computer readable medium of claim 9 further containing instructions that, when executed by a processor on a computing device, cause the computing device to:
display to a dental assistant a list of dental services to be selected wherein the list includes the first dental service;
receive a selection by the dental assistant of the first dental service;
display the uploaded image of the tray layout of dental instruments and materials for the first dental service; and
display a list of categories to be selected by the dental assistant for the selected dental service including instruments, materials, dental codes, and equipment used for the selected dental service and display the inputted instruments, materials, dental codes, and equipment used for the selected dental service based on the category selected.

11. The non-transitory computer readable medium of claim 10 further containing instructions that, when executed by a processor on a computing device, cause the computing device to:
receive a selection by the dental assistant to watch a video illustrating the first dental service and display the uploaded video.

12. The non-transitory computer readable medium of claim 9 further containing instructions that, when executed by a processor on a computing device, cause the computing device to:
store one or more inputted dental procedure codes by the dental office for dental services associated with the first dental service.

13. The non-transitory computer readable medium of claim 9 further containing instructions that, when executed by a processor on a computing device, cause the computing device to:
store inputted information by the dental office relevant to insurance coverage for a dental service by a particular insurance company.

14. The non-transitory computer readable medium of claim 9 further containing instructions that, when executed by a processor on a computing device, cause the computing device to:
store inputted a description of service by the dental office for the first dental service.

15. The non-transitory computer readable medium of claim 9 further containing instructions that, when executed by a processor on a computing device, cause the computing device to:
store an uploaded consent form by the dental office.

16. The non-transitory computer readable medium of claim 9 further containing instructions that, when executed by a processor on a computing device, cause the computing device to:
store an uploaded image of an object of a dental service before the dental service and an image of the object of the dental service after the dental service by the dental office.
